(19) United States
(12) Patent Application Publication
(10) Pub. No.: US 2012/0232184 A1
(43) Pub. Date: Sep. 13, 2012

(54) Environmentally Friendly Polyamide Resin Composition and Molded Product Using the Same

(75) Inventors: Young-Chul KWON, Uiwang-si (KR); Doo-Han HA, Uiwang-si (KR); Hyung-Tak LEE, Uiwang-si (KR); Bong-Jae LEE, Uiwang-si (KR); Chang-Do JUNG, Uiwang-si (KR)

(73) Assignee: CHEIL INDUSTRIES INC., Gumi-si (KR)

(21) Appl. No.: 13/479,583

(22) Filed: May 24, 2012

Related U.S. Application Data
(63) Continuation-in-part of application No. PCT/KR2010/007609, filed on Nov. 1, 2010.

(30) Foreign Application Priority Data
Nov. 25, 2009 (KR) 10-2009-0114805

(51) Int. Cl. C08L 77/00

(52) U.S. Cl. 523/122; 524/502

(57) ABSTRACT

Provided are an environmentally-friendly polyamide resin composition that includes (A-1) a first polyamide resin including polyamide 11, polyamide 1010, or a combination thereof, (B) a glass fiber having a cross-sectional aspect ratio of about 1.5 or more, and (C) a branched graft copolymer including a polyolefin main chain, and optionally (A-2) second polyamide resin including a C6 organic chain in one repeating unit, and a molded product using the same.

### CROSS-REFERENCE TO RELATED APPLICATIONS

This application is a continuation-in-part of International Application No. PCT/KR2010/007609, filed Nov. 1, 2010, pending, which designates the U.S., published as WO 2011/065678, and is incorporated herein by reference in its entirety, and claims priority therefrom under 35 USC Section 120. This application also claims priority under 35 USC Section 119 from Korean Patent Application No. 10-2009-0114805, filed Nov. 25, 2009, in the Korean Intellectual Property Office, the entire disclosure of which is also incorporated herein by reference.

### FIELD

This disclosure relates to an environmentally-friendly polyamide resin composition and a molded product using the same.

### BACKGROUND

Generally, when a thermoplastic resin is reinforced with glass fiber, the thermoplastic resin can have improved tensile strength and flexural strength while maintaining its intrinsic property of excellent formability. Further, thermoplastic resin with excellent flexural modulus and heat resistance can be used for parts that continuously receive weight or have to endure continuous heat. Glass fiber reinforced thermoplastic resins can have these properties and thus can be useful for in a variety of parts for vehicles and electronic products.

Glass fiber reinforced thermoplastic resins, however, can exhibit significantly decreased fluidity due to the addition of the glass fiber. Thus the temperature using during injection molding processes for glass fiber reinforced thermoplastic resins typically has to be increased. Also, when the glass fiber reinforced thermoplastic resin is injection-molded, a plastic molded product formed of the glass fiber reinforced thermoplastic resin may be warped or twisted because the molded product can have different contraction rates in the injection and vertical directions due to fiber orientation resulting during the flow of the thermoplastic resin. This in turn can deteriorate the quality of the plastic molded product.

Moreover, impact resistance of the glass fiber reinforced thermoplastic resin can decrease, as compared to the impact resistance of the thermoplastic resin before glass fiber is added thereto. As a result, the glass fiber reinforced thermoplastic resin may not be used for parts that may be damaged or destroyed by external impact.

To overcome the problem of deteriorated impact resistance caused by the addition of the glass fiber, an impact-reinforcing agent such as a core-shell graft copolymer can also be added to a resin, such as a polycarbonate resin. However, after the core-shell graft copolymer is added, the fluidity of the polycarbonate resin can be deteriorated, and because of the deteriorated fluidity, the glass fiber can be destroyed during the extrusion process and impact resistance may not be improved.

Also, since the thermoplastic resin is formed of a petroleum-based material, the amount of CO₂ generated can be high, which can cause environmental pollution.

### SUMMARY

One embodiment provides an environmentally-friendly polyamide resin composition that can have excellent impact resistance, hardness, heat resistance, and warpage properties.

Another embodiment provides a molded product made using the environmentally-friendly polyamide resin composition.

An exemplary embodiment provides an environmentally-friendly polyamide resin composition that includes (A-1) about 20 to about 90 parts by weight of a first polyamide resin including polyamide 11, polyamide 1010, or a combination thereof; (A-2) about 0 to about 50 parts by weight of a second polyamide resin including a C6 organic chain in one repeating unit; (B) about 9 to about 80 parts by weight of a glass fiber having a cross-sectional aspect ratio of about 1.5 or more; and (C) about 1 to about 5 parts by weight of a branched graft copolymer including a polyolefin main chain, the amount of each based on about 100 parts by weight of (A-1), (A-2), (B), and (C) components.

The first polyamide resin (A-1) may include a bio-polyamide resin derived from a vegetable fiber.

The second polyamide resin (A-2) may include polyamide 6, polyamide 66, or a combination thereof.

The glass fiber (B) may further include another glass fiber having a cross-sectional aspect ratio of less than about 1.5.

The branched graft copolymer including a polyolefin main chain (C) may include a polyolefin main chain on which a reactive group including a (meth)acrylate group, a modified ester group, an arylate group, an acrylonitrile group, or a combination thereof is grafted. The branched graft copolymer may include the reactive group may in an amount of about 5 to about 50 wt % based on the total weight of the branched graft copolymer including a polyolefin main chain (C).

The environmentally-friendly polyamide resin composition may further include about 0.1 to about 30 parts by weight of an additive, based on about 100 parts by weight of the above (A-1), (A-2), (B), and (C) components. Examples of the additive include without limitation antibacterial agents, heat stabilizers, release agents, light stabilizers, inorganic material additives, surfactants, coupling agents, plasticizers, admixtures, weather-resistance agents, colorants, a stabilizers, lubricants, antistatic agents, colorant aids, flameproofing agents, ultraviolet (UV) absorbers, ultraviolet (UV) blocking agents, filler, nucleating agents, adhesion aids, adhesives, and combinations thereof.

Another exemplary embodiment provides a molded product made using the environmentally-friendly polyamide resin composition.

Hereinafter, further aspects of the present invention will be described in detail.

The polyamide resin composition can be environmentally friendly and also can have excellent impact resistance, hardness, heat resistance, and/or warpage properties. The polyamide resin may be used in a variety of molding products, such as but not limited to molded housings for electronic products and molded exterior parts for vehicles.

### BRIEF DESCRIPTION OF THE DRAWING

FIG. 1 is a schematic view showing a cross-sectional aspect ratio of a glass fiber according to one embodiment.

### DETAILED DESCRIPTION

The present invention will be described more fully hereinafter in the following detailed description of the invention, in which some but not all embodiments of the invention are described. Indeed, this invention may be embodied in many different forms and should not be construed as limited to the embodiments set forth herein; rather, these embodiments are provided so that this disclosure will satisfy applicable legal requirements.

In the present specification, when a specific definition is not otherwise provided, the term “(meth)acrylate group” refers to an “acrylate group” and an “methacrylate group.”

An environmentally-friendly polyamide resin composition according to one embodiment includes (A-1) a first polyamide resin including polyamide 11, polyamide 1010, or a combination thereof, (B) a glass fiber having a cross-sectional aspect ratio of about 1.5 or more, and (C) a branched graft copolymer including a polyolefin main chain, and optionally (A-2) a second polyamide resin including a C6 organic chain in one repeating unit.

Each component included in the environmentally-friendly polyamide resin composition according to one embodiment will hereinafter be described in detail.

(A-1) First Polyamide Resin

The first polyamide resin is a bio-polyamide resin.

The bio-polyamide resin is an environmentally-friendly material that may remarkably decrease the amount of CO₂ generated during the production of plastics, and it is vegetable fiber, specifically, non-food resources originating from castor which may be easily cultivated. The bio-polyamide resin satisfies the aspects of both environmentally-friendly property and application of non-food resources.

Examples of the bio-polyamide resin may include without limitation polyamide 11, polyamide 1010, and the like, and combinations thereof.

Polyamide 11 is known in the art and is commercially available or can be readily produced by the skilled artisan without undue experimentation. For example, polyamide 11 can be manufactured from castor oil, which is a vegetable oil. Since castor oil has a low absorption rate, it may be used in products requiring low dimensional stability. In exemplary embodiments, the polyamide 11 may be manufactured from ricinoleic acid of castor oil by polycondensing an undecanoic acid.

Polyamide 1010 also is known in the art and is commercially available or can be readily produced by the skilled artisan without undue experimentation. For example, polyamide 1010 may be manufactured by condensing sebacic acid obtained from castor oil and 1,10-decamethylenediamine obtained by aminating sebacic acid, and polyamide 1010 originates from 100% biomass.

Since polyamide 11 and polyamide 1010 have a low moisture absorption rate, they can be stable against deformation during a molding process.

According to one embodiment, polyamide 11 and polyamide 1010 may not only be used alone but also used together in the form of a mixture. When they are used by being mixed together, polyamide 11 may be included in an amount of about 50 to about 99 wt % and polyamide 1010 may be included in an amount of about 1 to about 50 wt %.

In some embodiments, the mixture of polyamide 11 and polyamide 1010 may include polyamide 11 in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of polyamide 11 can be in a range from about any of the foregoing amounts to about any other of the foregoing amounts.

In some embodiments, the mixture of polyamide 11 and polyamide 1010 may include polyamide 1010 in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of polyamide 1010 can be in a range from about any of the foregoing amounts to about any other of the foregoing amounts.

When a mixture including polyamide 11 and polyamide 1010 in the above amounts is used, impact resistance, heat resistance and hardness can be improved.

The environmentally-friendly polyamide resin composition may include the bio-polyamide resin (such as polyamide 11, polyamide 1010, and the like, and combinations thereof as described herein) in an amount of about 20 to about 90 parts by weight, for example about 25 to about 80 parts by weight, based on about 100 parts by weight of environmentally-friendly polyamide resin composition, that is, the total amount of about 100 parts by weight of (A-1) the first polyamide resin, (A-2) the second polyamide resin, (B) the glass fiber, and (C) the branched graft copolymer.

In some embodiments, the environmentally-friendly polyamide resin composition may include the bio-polyamide resin in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 parts by weight. Further, according to some embodiments of the present invention, the amount of the bio-polyamide resin can be in a range from about any of the foregoing amounts to about any other of the foregoing amounts.

When the bio-polyamide resin is included in an amount within the above range, the environmentally-friendly polyamide resin composition can be environmentally-friendly and further can exhibit excellent impact resistance, hardness, and heat resistance.

(A-2) Second Polyamide Resin

The second polyamide resin may be a generally-used (conventional) polyamide resin that is different from the first polyamide (A-1).

The generally-used polyamide resin may be optionally added to the environmentally-friendly polyamide resin composition according to one embodiment.

Examples of the generally-used polyamide resin include without limitation polyamide resins with an amide-group in the polymer main chain. Generally-used polyamide resins are known in the art and are commercially available and also can be readily produced by the skilled artisan without undue experimentation. For example, an amino acid, lactam or diamine, and dicarboxylic acid as main components can be polymerized to provide a polyamide.

Examples of the amino acid may include without limitation 6-aminocaproic acid, 11-aminoundecanoic acid, 12-aminododecanoic acid, paraminomethylbenzoic acid, and the like, and combinations thereof. Examples of the lactam may include without limitation c-caprolactam, w-laurolactam, and the like, and combinations thereof. Examples of the diamine may include without limitation aliphatic, alicyclic or aromatic diamines such as tetramethylenediamine, hexamethylenediamine, 2-methylpentamethylenediamine, nonamethylenediamine, undecamethylenediamine, dodecamethylenediamine, 2,2,4-trimethylhexamethylenediamine, 2,4,4-trimethylhexamethylenediamine, 5-methylnonamethylenediamine, metaxylenediamine, paraxylenediamine, 1,3-bis(aminomethyl)cyclohexane, 1,4-bis(aminomethyl)cyclohexane, 1-amino-3-aminomethyl-3,5,5-trimethylcyclohexane, bis (4-aminocyclohexyl)methane, bis(3-methyl-4-aminocyclohexyl)methane, 2,2-bis (4-aminocyclohexyl)propane, bis(aminopropyl)piperazine, aminoethylpiperazine, and the like, and combinations thereof. Examples of the dicarboxylic acid may include without limitation aliphatic, alicyclic or aromatic dicarboxylic acids such as adipic acid, suberic acid, azelaic acid, sebacic acid, dodecane2 acid, terephthalic acid, isophthalic acid, 2-chloroterephthalic acid, 2-methylterephthalic acid, 5-methylisophthalic acid, 5-sodiumsulfoisophthalic acid, 2,6-naphthalenedicarboxylic acid, hexahydroterephthalic acid, hexahydroisophthalic acid, and the like, and combinations thereof. A polyamide homopolymer or copolymer derived from a raw material may be used singularly or as a mixture.

The generally-used polyamide resin according to one embodiment may be a polyamide resin with a C6 organic chain in one repeating unit thereof.

Examples of such a polyamide resin may include without limitation polyamide 6, polyamide 66, and the like, and combinations thereof. The term polyamide 6 refers to polycaprolactam and it includes a C6 organic chain represented by —CH₂₅CO— in one repeating unit. The term polyamide 66 refers to polyhexamethyleneadipamide and it includes a C6 organic chain represented by —CO CH₂₄CO— in one repeating unit.

By using the generally-used polyamide resin along with the above-described bio-polyamide resin, hardness and heat resistance may be improved while maintaining low moisture absorption rate.

The environmentally-friendly polyamide resin composition may include the generally-used polyamide resin in an amount of about 0 to about 50 parts by weight, for example about 5 to about 50 parts by weight, and as another example about 10 to about 50 parts by weight, based on about 100 parts by weight of environmentally-friendly polyamide resin composition, that is, the total amount of about 100 parts by weight of (A-1) the first polyamide resin, (A-2) the second polyamide resin, (B) the glass fiber, and (C) the branched graft copolymer.

In some embodiments, the environmentally-friendly polyamide resin composition may include the generally-used polyamide resin in an amount of 0 parts by weight (the generally-used polyamide resin is not present), about 0 (the generally-used polyamide resin is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 parts by weight. Further, according to some embodiments of the present invention, the amount of the generally-used polyamide resin can be in a range from about any of the foregoing amounts to about any other of the foregoing amounts.

When the generally-used polyamide resin is included in an amount within the above range, impact resistance, hardness, heat resistance and warpage properties can be improved.

(B) Glass Fiber

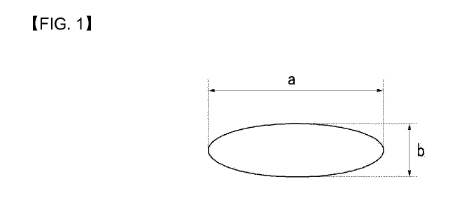

The glass fiber used herein has a flat cross section and has a particular aspect ratio. FIG. 1 is a schematic view showing a cross-sectional aspect ratio of a glass fiber according to one embodiment. Referring to FIG. 1, the aspect ratio is defined as a ratio of the longest diameter (a) to the shortest diameter (b) in a cross section of the glass fiber.

The glass fiber used herein may have a cross-sectional aspect ratio of about 1.5 or more, for example about 2 to about 8, and as another example about 2 to about 6. When the glass fiber has a cross-sectional aspect ratio within the about range, decreased fluidity of the environmentally-friendly polyamide resin composition caused by the addition of the glass fiber can be significantly decreased, and the orientation of the glass fiber due to the flow of the polyamide resin may be so small that the warpage properties of molded products manufactured from the environmentally-friendly polyamide resin composition may be improved.

The glass fiber may have a length of about 2 to about 13 mm, for example about 3 to about 6 mm.

Also, a glass fiber having a cross-sectional diameter of about 10 to about 20 μm may be used.

According to one embodiment, the above-described glass fiber having a cross-sectional aspect ratio of greater than or equal to about 1.5 may be mixed and used with a glass fiber having a cross-sectional aspect ratio of less than about 1.5. When the mixture of the glass fibers is used, the glass fiber having a cross-sectional aspect ratio of about 1.5 or more may be included in an amount of about 20 to about 99 wt %, and the glass fiber having a cross-sectional aspect ratio of less than about 1.5 may be included in an amount of about 1 to about 80 wt %.

In some embodiments, the mixture of the glass fibers having a cross-sectional aspect ratio of about 1.5 or more and the glass fibers having a cross-sectional aspect ratio of less than about 1.5 may include the glass fibers having a cross-sectional aspect ratio of about 1.5 or more in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of the glass fibers having a cross-sectional aspect ratio of about 1.5 or more can be in a range from about any of the foregoing amounts to about any other of the foregoing amounts.

In some embodiments, the mixture of the glass fibers having a cross-sectional aspect ratio of about 1.5 or more and the glass fibers having a cross-sectional aspect ratio of less than about 1.5 may include the glass fibers having a cross-sectional aspect ratio of less than about 1.5 in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt %. Further, according to some embodiments of the present invention, the amount of the glass fibers having a cross-sectional aspect ratio of less than about 1.5 can be in a range from about any of the foregoing amounts to about any other of the foregoing amounts.

When the glass fibers are used in an amount within the about mixing ratio, the workability and impact resistance of the environmentally-friendly polyamide resin composition may be maintained.

The glass fiber may be coated with a predetermined material to prevent a reaction of a polyamide resin and improve immersion degree.

The environmentally-friendly polyamide resin composition may have different overall fluidity and impact resistance according to the kind of the coating material. The kinds of material that can be used to coat the surface of the glass fiber are known to a person of an ordinary skill in the art.

The environmentally-friendly polyamide resin composition may include glass fiber with a cross-sectional aspect ratio of about 1.5 or more in an amount of about 9 to about 80 parts by weight, for example about 20 to about 70 parts by weight, based on about 100 parts by weight of environmentally-friendly polyamide resin composition, that is, the total amount of about 100 parts by weight of (A-1) the first polyamide resin, (A-2) the second polyamide resin, (B) the glass fiber, and (C) the branched graft copolymer. In some embodiments, the environmentally-friendly polyamide resin composition may include the glass fiber with a cross-sectional aspect ratio of about 1.5 or more in an amount of about 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 parts by weight. Further, according to some embodiments of the present invention, the amount of the glass fiber with a cross-sectional aspect ratio of about 1.5 or more can be in a range from about any of the foregoing amounts to about any other of the foregoing amounts.

When the glass fiber is included in an amount within the above range, the hardness and heat resistance of the environmentally-friendly polyamide resin composition can be improved and the fluidity also can be greatly improved, which can provide excellent formability.

(C) Branched Graft Copolymer Including a Polyolefin Main Chain

The branched graft copolymer including a polyolefin main chain is a copolymer including a polyolefin main change grafted with a reactive group. The branched graft copolymer can serve as an impact reinforcing material by improving dispersion with a bio-polyamide resin, and it can minimize cutting of the glass fiber by decreasing the friction with a processing machine so as to improve impact resistance.

The polyolefin that forms the main chain may be polymerized from monomers such as but not limited to ethylene, propylene, isopropylene, butylene, isobutylene, and the like, and combinations thereof. In exemplary embodiments, polyethylene, polypropylene, ethylene-propylene copolymer or a combination thereof may be included in an amount of greater than or equal to about 70 wt % based on the total amount of the main chain.

The reactive group grafted into the main chain may include those having partial compatibility with a bio-polyamide resin. Examples of the reactive group grafted into the main chain include without limitation (meth)acrylate groups such as methyl(meth)acrylate, ethyl(meth)acrylate, and butyl(meth)acrylate; modified ester groups such as ethylene glycol; arylate groups such as phenolate groups and naphtholate groups; acrylonitrile groups; and the like, and combinations.

The branched graft copolymer may include the reactive group in an amount of about 5 to about 50 wt % based on the total amount of the branched graft copolymer including the polyolefin main chain, for example about 5 to about 40 wt %. In some embodiments, the branched graft copolymer may include the reactive group in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the reactive group can be in a range from about any of the foregoing amounts to about any other of the foregoing amounts.

When the reactive group is included in an amount within the above range, compatibility with the bio-polyamide resin can be excellent and the effect of impact reinforcement can be great so as to improve impact resistance.

The environmentally-friendly polyamide resin composition may include the branched graft copolymer including the polyolefin main chain in an amount of about 1 to about 5 parts by weight, for example about 3 to about 5 parts by weight, based on about 100 parts by weight of environmentally-friendly polyamide resin composition, that is, the total amount of about 100 parts by weight of (A-1) the first polyamide resin, (A-2) the second polyamide resin, (B) the glass fiber, and (C) the branched graft copolymer. In some embodiments, the environmentally-friendly polyamide resin composition may include the branched graft copolymer including the polyolefin main chain in an amount of about 1, 2, 3, 4, or 5 parts by weight. Further, according to some embodiments of the present invention, the amount of the branched graft copolymer including the polyolefin main chain can be in a range from about any of the foregoing amounts to about any other of the foregoing amounts.

When the environmentally-friendly polyamide resin composition includes the branched graft copolymer including the polyolefin main chain in an amount within the above range, the impact resistance and hardness of the environmentally-friendly polyamide resin composition can be excellent.

(D) Other Additive(s)

The environmentally-friendly polyamide resin composition according to one embodiment may further include one or more additives. Examples of the additives include without limitation antibacterial agents, heat stabilizers, release agents, light stabilizers, inorganic material additives, surfactants, coupling agents, plasticizers, admixtures, weather-resistance agents, colorants, stabilizers, lubricants, antistatic agents, colorant aids, flameproofing agents, ultraviolet (UV) absorbers, ultraviolet (UV) blocking agents, filler, nucleating agents, adhesion aids, adhesives, and the like, and combinations thereof.

Examples of the release agent may include without limitation fluorine-included polymers, silicone oils, metal salts of stearic acid, metal salts of montanic acid, montanic acid ester waxes, polyethylene waxes, and the like, and combinations thereof. Examples of the weather-resistance agent may include without limitation benzophenone weather-resistance agents, weather resistance amine weather-resistance agents, and the like, and combinations thereof. Examples of the colorant may include without limitation dyes, pigments, and the like, and combinations thereof. Examples of the ultraviolet (UV) blocking agent may include without limitation titanium oxide (TiO₂), carbon black, and the like, and combinations thereof. Examples of the filler may include without limitation glass fiber, carbon fiber, silica, mica, alumina, clay, calcium carbonate, calcium sulfate, glass beads, and the like, and combinations thereof. When the filler is added, properties such as a mechanical strength, heat resistance, and the like may be improved. Examples of the nucleating agent may include without limitation talc, clay, and the like, and combinations thereof.

The additive may be used so long as it does not significantly affect the properties of the environmentally-friendly polyamide resin composition and the type and amount thereof can vary depending on the use of the composition. The environmentally-friendly polyamide resin composition may include additive in an amount of about 0 to about 30 parts by weight, for example about 0.1 to about 30 parts by weight, based on about 100 parts by weight of environmentally-friendly polyamide resin composition, that is, the total amount of about 100 parts by weight of (A-1) the first polyamide resin, (A-2) the second polyamide resin, (B) the glass fiber, and (C) the branched graft copolymer. In some embodiments, the environmentally-friendly polyamide resin composition may include additive in an amount of 0 (no additive is present), about 0 (additive is present), 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of additive can be in a range from about any of the foregoing amounts to about any other of the foregoing amounts.

The environmentally-friendly polyamide resin composition according to one embodiment may be prepared using any method well known to those skilled in the art. For example, the components and optionally additives may be mixed, fused in an extruder, and extruded in the form of pellets.

According to another embodiment, a molded product is fabricated by molding the environmentally-friendly polyamide resin composition described above. The environmentally-friendly polyamide resin composition may be used to produce a wide variety of diverse products requiring impact resistance, hardness, heat resistance, and dimensional stability, such as without limitation housings for electronic devices such as mobile phones, laptops, and other small and precise electronic products, sports utilities, and exterior components for vehicles.

The following examples illustrate the present invention in more detail. However, they are exemplary embodiments and are not limiting.

The environmentally-friendly polyamide resin composition according to one embodiment includes the following components.

(A-1) First Polyamide Resin

(A-1-1) A polyamide 11 which is commercially available as Rilsan KMVO from Arkema Corporation is used.

(A-1-2) A polyamide 1010 which is commercially available as Vestamid

Terra DS from Evonik Corporation is used.

(A-2) Second Polyamide Resin

A polyamide 6 which is commercially available as TP4210 from Zigsheng Corporation is used.

(B) Glass Fiber

(B-1) A glass fiber having a cross-sectional aspect ratio of 4 (the longest diameter of 28 μm and shortest diameter of 7 μm) and a length of 3 mm commercially available as CSG 3PA-820 from Nitto Boseki Corporation is used.

(B-2) A glass fiber having a cross-sectional aspect ratio of 1 (diameter of 10 μm) and a length of 3 mm, which is commercially available as P952 from Vetrotex Corporation is used.

(C) Branched Graft Copolymer Including a Polyolefin Main Chain

Elvaloy 1224AC of Dupont Corporation is used.

### Examples 1 to 18 and Comparative Examples 1 to 8

The above components in amounts of shown in the following Tables 1 and 2 are extruded in a general twin-screw extruder and the extruded products are prepared in the form of pellets.

### Experimental Examples

Physical specimens are manufactured by drying pellets manufactured according to Examples 1 to 18 and Comparative Examples 1 to 8 at 100° C. for 4 hours, and then injecting under the conditions of plastic temperature of 250 to 270° C. and molding temperature of 60 to 80° C. with a 10-oz injection molding machine. The physical properties of the physical specimens are measured using the following methods and the results are shown in the following Tables 1 and 2.

(1) Impact strength (⅛″) is measured according to ASTM D256.

(2) Flexural hardness is measured according to ASTM D790 (2.8 mm/min).

(3) Thermal distortion temperature is measured according to ASTM D648 (18.56 kgf).

(4) Warpage: square specimens of 6″×6″× 1/16″ thin film are injected and their extent of warpage after discharge are determined and ranked as follows:

Extent of warpage: 0 (no warpage) 5 (severely warped)

TABLE 1
The following parts by weight units are based on 100 parts
by weight of (A-1), (A-2), (B) and (C) components.

| | | | Examples | | | | | | | | |
|---|---|---|---|---|---|---|---|---|---|---|---|
| | | unit | 1 | 2 | 3 | 4 | 5 | 6 | 7 | 8 | 9 |
| (A-1) | (A-1-1) | parts by weight | 24 | 34 | 48 | 58 | 66 | 76 | 86 | 50 | 19 |
| | (A-1-2) | parts by weight | — | — | — | — | — | — | — | — | — |
| (A-2) | | parts by weight | — | — | — | — | — | — | — | — | 48 |
| (B) | (B-1) | parts by weight | 72 | 62 | 48 | 38 | 29 | 19 | 9 | 49 | 29 |
| | (B-2) | parts by weight | — | — | — | — | — | — | — | — | — |
| (C) | | parts by weight | 4 | 4 | 4 | 4 | 5 | 5 | 5 | 1 | 4 |
| Impact strength | | kg · cm/cm | 30 | 30 | 30 | 25 | 22 | 20 | 16 | 27 | 9 |
| Flexural hardness | | kgf/cm2 | 12 | 10 | 8 | 7 | 5.5 | 5.2 | 5.2 | 8.5 | 7.5 |
| Thermal distortion | | ° C. | 180 | 180 | 180 | 180 | 180 | 180 | 180 | 180 | 190 |
| temperature | | | | | | | | | | | |
| Warpage | | — | 0 | 0 | 0 | 0 | 0 | 0 | 0 | 0 | 0 |
| | | | Examples | | | | | | | | |
| | | unit | 10 | 11 | 12 | 13 | 14 | 15 | 16 | 17 | 18 |
| (A-1) | (A-1-1) | parts by weight | 29 | 38 | 48 | 57 | — | — | 29 | — | 69 |
| | (A-1-2) | parts by weight | — | — | — | — | 29 | 48 | — | 29 | — |
| (A-2) | | parts by weight | 38 | 29 | 19 | 10 | 38 | 19 | 5 | 5 | — |
| (B) | (B-1) | parts by weight | 29 | 29 | 29 | 29 | 29 | 29 | 62 | 62 | 30 |
| | (B-2) | parts by weight | — | — | — | — | — | — | — | — | — |

| | | | | | | | | | | |
|---|---|---|---|---|---|---|---|---|---|---|
| (C) | parts by weight | 4 | 4 | 4 | 4 | 4 | 4 | 4 | 4 | 1 |
| Impact strength | kg · cm/cm | 10 | 10 | 12 | 16 | 12 | 12 | 27 | 15 | 18 |
| Flexural hardness | kgf/cm2 | 7 | 6.7 | 6.2 | 6.0 | 7.3 | 7.3 | 11 | 15 | 6.0 |
| Thermal distortion | ° C. | 190 | 185 | 184 | 182 | 192 | 188 | 180 | 190 | 180 |
| temperature | | | | | | | | | | |
| Warpage | — | 0 | 0 | 0 | 0 | 0 | 0 | 0 | 0 | 0 |

TABLE 2

| | | | Comparative Examples | | | | | | | |
|---|---|---|---|---|---|---|---|---|---|---|
| | | unit | 1 | 2 | 3 | 4 | 5 | 6 | 7 | 8 |
| (A-1) | (A-1-1) | parts by weight | 14 | 91 | 70 | 64 | 67 | — | — | 66 |
| | (A-1-2) | parts by weight | — | — | — | — | — | — | — | — |
| (A-2) | | parts by weight | — | — | — | — | 70 | 70 | — | — |
| (B) | (B-1) | parts by weight | 82 | 5 | 30 | 27 | — | 30 | — | 28 |
| | (B-2) | parts by weight | — | — | — | 29 | — | 30 | — | — |

| | | | | | | | | | |
|---|---|---|---|---|---|---|---|---|---|
| (C) | parts by weight | 4 | 4 | — | 9 | 4 | — | — | 6 |
| Impact strength | kg · cm/cm | Impossible | 4 | 6 | 16 | 13 | 7 | 7 | 20 |
| Flexural hardness | kgf/cm2 | to be | 1.7 | 7.0 | 4.0 | 5.5 | 7.6 | 7.5 | 4.2 |
| Thermal distortion | ° C. | extruded | 50 | 180 | 180 | 180 | 210 | 210 | 180 |
| temperature | | | | | | | | | |
| Warpage | — | | 0 | 2 | 1 | 3 | 2 | 5 | 1 |

It may be seen from Tables 1 and 2 that Examples 1 to 18 which include a bio-polyamide resin, a glass fiber having a cross-sectional aspect ratio of about 1.5 or more, a branched graft copolymer including a polyolefin main chain, and optionally a generally-used polyamide resin exhibit excellent impact resistance, hardness, heat resistance, and warpage properties.

In addition, Examples 9 to 17 which include a generally-used polyamide resin such as polyamide 6 exhibit improved hardness and heat resistance.

On the other hand, Comparative Example 1, which includes glass fiber in an amount outside of the range of the invention, cannot be extruded and thus no physical properties are obtained. Comparative Example 2, which includes bio-polyamide resin and glass fiber in amounts outside of the range of the invention, exhibit deteriorated impact resistance, hardness, and heat resistance. Comparative Examples 3 and 4, which did not include branched graft copolymer including a polyolefin main chain or which include branched graft copolymer including a polyolefin main chain in an amount outside of the range of the invention, exhibit deteriorated impact strength and hardness, respectively. Also, Comparative Example 5, which includes glass fiber having a cross-sectional aspect ratio of less than about 1.5, exhibits deteriorated warpage properties, and Comparative Examples 6 and 7, which did not include a bio-polyamide resin and a branched graft copolymer including a polyolefin main chain, exhibit deteriorated impact resistance and warpage properties. Comparative Example 8, which includes a branched graft copolymer including a polyolefin main chain in an amount outside of the range of the invention, exhibits deteriorated hardness.

Therefore, it may be seen that the environmentally-friendly polyamide resin composition according to one embodiment can exhibit a balance of various properties, and thus can be environmentally-friendly and also can exhibit excellent physical properties such as impact resistance, hardness, heat resistance, and warpage.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. An environmentally-friendly polyamide resin composition, comprising:
(A-1) about 20 to about 90 parts by weight of a first polyamide resin including polyamide 11, polyamide 1010, or a combination thereof, based on about 100 parts by weight of (A-1), (A-2), (B), and (C);
(A-2) about 0 to about 50 parts by weight of a second polyamide resin including a C6 organic chain in one repeating unit, based on about 100 parts by weight of (A-1), (A-2), (B), and (C);
(B) about 9 to about 80 parts by weight of a glass fiber having a cross-sectional aspect ratio of about 1.5 or more, based on about 100 parts by weight of (A-1), (A-2), (B), and (C); and
(C) about 1 to about 5 parts by weight of a branched graft copolymer including a polyolefin main chain, based on about 100 parts by weight of (A-1), (A-2), (B), and (C).

2. The environmentally-friendly polyamide resin composition of claim 1, wherein the first polyamide resin (A-1) comprises a bio-polyamide resin derived from a vegetable fiber.

3. The environmentally-friendly polyamide resin composition of claim 1, wherein the second polyamide resin (A-2) comprises polyamide 6, polyamide 66, or a combination thereof.

4. The environmentally-friendly polyamide resin composition of claim 1, wherein the glass fiber (B) further comprises another glass fiber having a cross-sectional aspect ratio of less than about 1.5.

5. The environmentally-friendly polyamide resin composition of claim 1, wherein the branched graft copolymer including a polyolefin main chain (C) comprises a polyolefin main chain on which a reactive group including a (meth)acrylate group, a modified ester group, an arylate group, an acrylonitrile group, or a combination thereof is grafted.

6. The environmentally-friendly polyamide resin composition of claim 5, wherein the reactive group is included in an amount of about 5 to about 50 wt % based on the total amount of the branched graft copolymer including a polyolefin main chain (C).

7. The environmentally-friendly polyamide resin composition of claim 1, wherein the environmentally-friendly polyamide resin composition further comprises about 0.1 to about 30 parts by weight of an additive including an antibacterial agent, a heat stabilizer, a release agent, light stabilizer, an inorganic material additive, a surfactant, a coupling agent, a plasticizer, admixture, a weather-resistance agent, a colorant, a stabilizer, a lubricant, an antistatic agent, an colorant aid, a flameproofing agent, an ultraviolet (UV) absorber, an ultraviolet (UV) blocking agent, a filler, a nucleating agent, an adhesion aid, an adhesive, or a combination thereof, based on the sum, 100 parts by weight of the (A-1), (A-2), (B), and (C) components.

8. A molded product made using the environmentally-friendly polyamide resin composition of claim 1.
